(19) United States
(12) Patent Application Publication
(10) Pub. No.: US 2013/0226876 A1
(43) Pub. Date: Aug. 29, 2013

(54) SYNCHRONIZING LOCAL CLIENTS WITH A CLOUD-BASED DATA STORAGE SYSTEM

(71) Applicant: Construcs, Inc., San Francisco, CA (US)

(72) Inventors: Ari Gati, Santa Monica, CA (US); Richard Barber, Berkeley, CA (US); Trevor Seemann, Ladera Ranch, CA (US)

(73) Assignee: Construcs, Inc., San Francisco, CA (US)

(21) Appl. No.: 13/779,082

(22) Filed: Feb. 27, 2013

Related U.S. Application Data
(60) Provisional application No. 61/604,812, filed on Feb. 29, 2012.
(60) Provisional application No. 61/678,573, filed on Aug. 1, 2012.

(51) Int. Cl. G06F 17/30

(52) U.S. Cl. CPC G06F 17/30079
USPC 707/652

(57) ABSTRACT

A system and a method are disclosed for receiving a file at a cloud-based storage system and storing the file in the file structure of the cloud-based storage system. Once received, the file, the name of the file, and its storage location in the cloud storage are associated with a unique identifier created for the file. The file, when provided to at least one user client, can be stored by the user client in a user-defined file structure that is different from the cloud-based storage system file structure. Because of the unique identifier associated with the file and the cloud-based storage location, the locally stored files can still be synchronized with file stored at the cloud-storage location.

### CROSS REFERENCE TO RELATED APPLICATIONS

This application claims the benefit of U.S. Provisional Application Nos. 61/604,812, filed Feb. 29, 2012, and 61/678,573, filed Aug. 1, 2012, which are incorporated by reference in their entirety.

### BACKGROUND

1. FIELD OF ART

The disclosure generally relates to the field of data storage. Specifically, this disclosure relates to synchronizing local clients with cloud-based data storage systems.

2. DESCRIPTION OF THE RELATED ART

Cloud-based data storage is used by enterprises and individuals to store data in a network rather than on a specific device in order to more conveniently and inexpensively access it from any device when so desired. One feature of cloud storage systems is that they store files and data in a traditional hierarchical folder/file organizational structure that is analogous to the folder/file organizational structure used in local storage or in shared, non-cloud storage.

However, merely enabling other users to access folders and files in a cloud-based storage system when using traditional hierarchical folder/file organizational paradoxically decreases the ability of some users to conveniently access these files for at least two reasons. First, finding a shared document stored in a cloud-based storage system can be challenging without an understanding of the folder/file organizational structure. That is, a shared file can be buried within multiple folders and sub-folders and, even though accessible, is difficult or impractical to find. Second, conveniently finding files within the hierarchical folder/file organizational structure is usually facilitated by understanding of file and folder naming conventions that is often the exclusive province of the authors of the files and folder system. For at least these reasons, the utility of sharing files using cloud-based storage is decreased.

Additionally, often the person sharing a file does not intend to share some or all of the other files in a folder, but instead intends to share a subset of the files within the folder. This is problematic for cloud-based data sharing systems which share the entire contents of a folder, and as a result, detracts from the convenience of using cloud-based storage systems to store and share files.

Furthermore, cloud-based storage systems can be cumbersome for the local device of the user to maintain. This is due, in part, to the synchronization (“sync”) process used to update files modified locally but stored at a cloud-based storage location. When a locally modified document is synced with the cloud-based storage system, all files or selected folders are synchronized. This can make it difficult to manage disk storage space on the local client of the user.

Users of cloud-based storage systems have developed inconvenient techniques for circumventing these problems. For example, a user can either explicitly create a web link to an individual file by, for example, sending the file with an expiration date or by creating a new folder to share only those files that are intended to be shared. In doing this, the sharing user essentially copies only the files intended to be shared into a new folder and then shares that folder with one or multiple individuals or groups. Unfortunately, in doing so, multiple copies of the files are created. A drawback of this is that the multiple copies and folders are difficult to keep synchronized across all folders and file copies, and these multiple copies are prone to disorganization. Users may easily update one file not realizing that the copies created within other folders are not updated. As a result, users see old versions. Additionally with all the copies created by users to facilitate sharing, storage space on the local client becomes challenging.

Accordingly, cloud based storage continues to lack flexibility and practicality of use for users in a variety of situations.

### BRIEF DESCRIPTION OF DRAWINGS

The disclosed embodiments have other advantages and features that will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2 illustrates one example embodiment of a system for providing and synchronizing a file from a cloud-based storage system to a user client, the file stored at the client in a file structure different from the file structure of the cloud storage system.

FIG. 3 illustrates one example embodiment of a method for providing and synchronizing a file from a cloud-based storage system to a user client, the file stored at the client in a file structure different from the file structure of the cloud storage system.

FIG. 4 illustrates one example embodiment of a method for opening a file using a browser, whether the file is stored locally or at a cloud storage system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes features enabling files and/or objects to be transmitted and synchronized (“synced”) from a cloud-based storage system (“cloud storage system”) to at least one user device and stored locally at a user's computing device in at least one user-defined file structure that is different from the file structure of the cloud system. In some examples of this embodiment, the user-defined file structure is created using user preferences applied by the system to the files and folders to automatically create the user-defined file structure, as opposed to the user manually creating the file structure folder by folder. Users may also name the locally stored file with a user defined name that is different from the name of the file stored at the cloud storage system or store the file at multiple locations at a user computing device. This enables the organizational structure of the files and folders to be individualized by each user, without changing the organizational structure of the cloud storage system. Users can then more conveniently locate and use documents stored in a cloud-based storage service by storing the files using their own file organization system and their own file naming conventions. In another embodiment, the file structures at the user device and the cloud storage system may be the same even though they are still defined by user preferences.

As used herein, the terms file structure, file organization, and file hierarchy are used interchangeably, and refer to the folder/sub-folder hierarchy typically used to organize storage files in a window-based computer graphical user interface. Furthermore, the term “file contents” refers to the content of a file, the term “file meta-data” refers to (but is not limited to) information describing the storage location (such as a file path) of file contents, a unique identifier associated with the file, a version number and the calendar date and time of the most recent revision of the file contents. The term “file” refers to the file contents and the file meta-data collectively.

In one example of this embodiment, a file is received at the cloud storage system and stored at a location within the cloud storage system file structure, for example, within a particular file folder and sub-folder. A unique identifier is created for the file and associated with the file name, a hash of the file contents, and the storage location of the file contents within the cloud storage system file structure. The file contents can then be provided, along with the unique file identifier, to a user client. The file can be stored locally on the user client in a file structure determined by the user and different from the file structure used to store the file at the cloud storage system. This enables the organizational structure of the files and folders to be individualized by a user without changing the organizational structure of the cloud storage system.

### Computing Machine Architecture

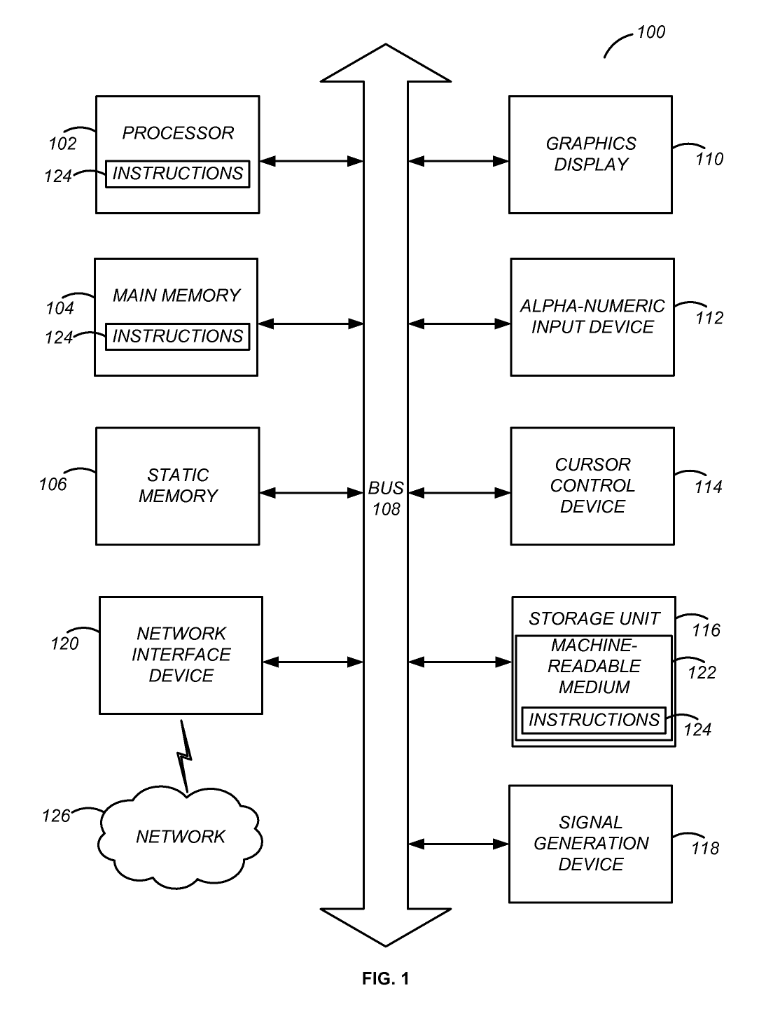

FIG. (FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### System Architecture

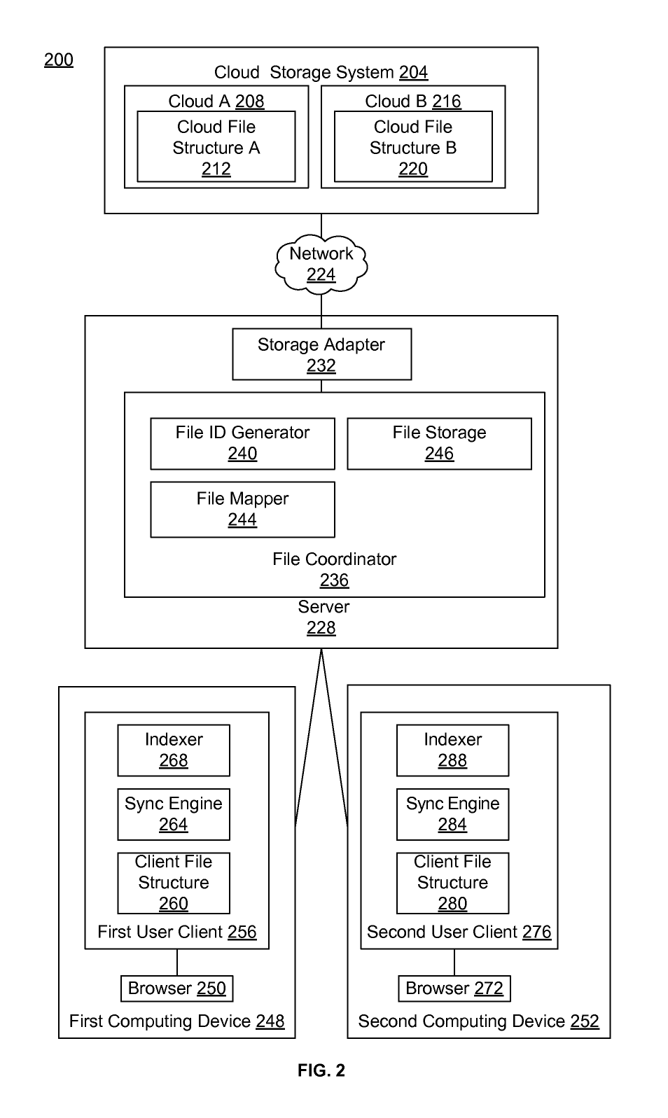

FIG. 2 illustrates an example an architecture of a system 200 for providing file contents from a server to a cloud storage system, synchronizing files between computing devices and the cloud storage system, and permitting users to define local file structures that differ from the file structure at the cloud storage system. The file contents, as well as meta-data including the cloud storage location, file contents version, a hash of the file contents, and other meta-data, can also be provided to a user computing device, e.g., a device structured like the computer system 100. The user defined local file structure can be created upon downloading the file by reference to stored user preferences that use file meta-data to create a file path (e.g., folders and sub-folders) used store files.

The system 200 is also configured to search for a most recent version of file contents locally before searching at other storage locations, such as at a local area network server, or the cloud based storage system. This search can be executed prior to downloading the file from the cloud storage system. This local search can conserve local computational resources and network bandwidth, and avoids unnecessary downloads of duplicate file contents. Additionally, the system 200 is configured to identify and resolve version conflicts between file contents stored at the user client and corresponding file contents stored at the cloud storage system. Further benefits of the system for sharing and synchronization of files locally and with the cloud storage system will be discussed in more detail below.

The system 200 includes a cloud storage system 204, a network 224, a server 228, and at least one computing device 248. Within the at least one computing device 248 is a first user client 252 and sub-elements which are described in more detail below.

In this example, the cloud storage system 204, used to store the contents of one or more files, includes one or more cloud storage providers (“clouds”), in this case cloud A 208 and cloud B 216. While only one cloud is necessary to store files provided to it by the system 200, the clouds 208 and 216 are shown to illustrate that the system 200 may optionally employ multiple clouds to store file contents without any discernable difference in operation or file organization at a computing device 248 and/or 252. The computing devices and machines forming the cloud may be structured similar to the computer system 100. Furthermore, as will also be explained below, files stored at one cloud, for example Cloud A 208, can be migrated to Cloud B 216 in a way that is also transparent to users.

Cloud A 208 and cloud B 216 are typically data centers that provide on-demand computing resources to the users (whether an individual or an enterprise) through virtualization. The customer typically is physically remote from the computing resource and is agnostic to the location of the physical resources that support the computing resources. In a virtualized cloud infrastructure, the computing resource generally comprises a virtual machine characterized by some amount of processor, memory, storage, networking capability or capacity. Virtualization allows the physical resources support a large number of computing resources, often well beyond the limited number of actual physical devices. Physical resources in the cloud infrastructure are shared amongst the different customers of the cloud infrastructure. Each customer gets the illusion of operating a physically distinct computing resource.

As shown, cloud A 208 and cloud B 220 have file structures A 212 and B 220, respectively. The file structures A 212 and B 220 can be unique to their respective clouds 208 and 216, and can also be independent of any file structure at the computing device 248. That is, as explained in further detail below, the organization of the files as stored in the clouds A 208 and B 220 need not be the same, or even similar, to each other or that of a computing device 248 and/or 252. In particular, this independence of file structure between a cloud and a computing device is unusual because typically the file structure of the cloud is imposed on the computing device accessing (or synchronizing with) the file at the cloud.

The network 224 may comprise any combination of local area and/or wide area networks, using both wired and wireless communication systems. In one embodiment, the network 224 uses standard communications technologies and/or protocols. Thus, the network 224 may include links using technologies such as Ethernet, 802.11, worldwide interoperability for microwave access (WiMAX), 3G, 4G, Long-term Evolution (LTE), CDMA, digital subscriber line (DSL), etc. Similarly, the networking protocols used on the network 224 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 224 may be represented using technologies and/or formats including hypertext markup language (HTML) or extensible markup language (XML). In addition, all or some of links may be encrypted using conventional encryption technologies such as secure sockets layer (SSL), transport layer security (TLS), and Internet Protocol security (IPsec).

The server 228 negotiates the transfer, synchronization, and coordination of files between the cloud storage system 204 and the computing devices 248 and 252 by accessing the appropriate communication protocol appropriate to either or both of cloud A 208 and cloud B 216. Elements of the server 228 also maintain a unique identification of file contents stored in either or both of cloud A and/or cloud B as compared to the file as stored at a user client on a computing device 248 and/or 252 and at the server 228. The server 228 includes a storage adapter 232 and a file coordinator 236.

The storage adapter 232 stores the application programming interfaces (“API”) for the one or more clouds, such as cloud A 208 and/or cloud B 216, within the cloud storage system 204. By interposing the storage adapter 232 between the cloud storage system 204 and one or more computing devices 248 and 252, the storage adapter can conveniently store files in multiple clouds by communicating with any cloud by using an application programming interface (“API”) call appropriate to the cloud.

To accomplish this, the storage adapter 232 includes one or more APIs containing instructions, permissions, and rules used to communicate with various clouds. For example, an API of the storage adapter 232 can communicate with cloud A 208 according to the requirements of cloud A′s application programming interface thereby accessing, storing, synchronizing, and/or editing a file. The storage adapter 232 thereby provides a single user interface at the user client 256 and/or 276 through which users interact with multiple clouds 208 and 216. Also, file contents can be migrated between clouds without changing the file structure or the user interface at a user.

The storage adapter 232 of the server 228 also provides protocols and tools used to perform various operations on files including, but not limited to, version control and setting file or folder permissions (e.g., administrator, read, read/write, share, etc.). In one embodiment, the storage adapter 232 can enact permissions and/or security credentials that are merely those permissions set by the cloud storage system 204 and/or the cloud A 208 and/or the cloud B 216. In another embodiment, the storage adapter 232 employs the least restrictive permissions at the cloud storage system 204, and imposes a separate permissions protocol specific to the user client 256 or 276 or to the server 228. In another embodiment, the system 204 permission rules are selectable by users through the user client 256 or 276.

The file coordinator 236 of the server 228 includes a file ID generator 240, a file mapper 244, and a file storage module 246. The file coordinator 236 functions to maintain the identity between files stored locally and the corresponding files stored at the cloud storage system 204.

The file ID generator 240 uniquely identifies each file with a unique file identifier so that the file can be saved to, and accessed from, any storage location independent of the file name. This enables users to name the file arbitrarily and save the file at a user client in a user-configured file structure (e.g., 260 and/or 280 as explained below) that is entirely independent from cloud file structure A 212 or cloud file structure B 220. The file ID generator 240, in some examples, generates a unique file ID by hashing the file contents with a cryptographic hash function (such as SHA-1, SHA-2, or md5hash). This produces a nearly unique identifier for the file that can be used ubiquitously throughout the system 200 to identify the file contents regardless of their storage location, or the name of file used by the user or the cloud storage system 204. In some examples, the file ID generator 240 actually receives a unique identifier provided by a cloud (e.g., cloud A 208). In this example, the file ID generator 240 need not generate a unique ID, but rather only confirms that the identifier provided by the cloud A 208 is actually unique and can be used to identify the file. Other methods of uniquely identifying the file exist and can be used with equal effect as the examples presented above. The unique identifier is passed to the file mapper 244 and the file storage module 246.

The file mapper 244 associates the unique identifier of each file with a storage location of the file in the cloud storage system 204 (e.g., in cloud file structure A 212 or cloud file structure B 220) in the meta-data of the file. The file mapper 244 helps to translate the cloud file structure 212 of the cloud storage system 204 into the client file structure 260 by storing the relationships correlating the cloud storage system file structure with the client file structure 260 in, for example, a relational database, that can be accessed or transmitted between systems (e.g., using RESTful web services). Other meta-data stored by the file mapper 244 and associated with the file includes, but is not limited to the cloud storage location (e.g., folder and/or sub-folders), the file type, the file category, and the most recent date that the file was modified or transmitted to or from the cloud storage system 204.

The file mapper 244 also associates the unique file identifier with other locations at which the file contents may be stored, such as in the 280 storage module 246 and/or in one or more locations within client file structures 260 and/or 276. Using the file mapper 244 to associate file contents through a unique file identifier to the various storage locations decouples the storage location of a file stored at a user computing device (e.g., first computing device 248) from the storage location of the file at, for example, cloud file structure A 212 of cloud A 208. This then allows the file stored at a first computing device to be named and stored at a file structure location that is independent from the name and storage location of the same file at a different cloud, such as cloud B 216. This is unlike conventional cloud storage systems which merely replicate the cloud storage file structure at a computing device.

A benefit of the file mapper 244 is that the relationship between files and, for example, the projects in which they are used can be easily changed without the inconvenience of reorganizing the files in the cloud storage system 204. Furthermore, by correlating the unique file identifier, the file name, and the location of the file contents in the cloud file structure A 212, the system 200 can move the file contents to the cloud B 216 and store them at a new location in cloud file structure B 220 without changing the presentation of the file, the file name, or the location of the file in the client file structure 260 at the first computing device 248. Rather, the storage location in the cloud file structure B 220 is updated at the file mapper 244 without changing anything at the first user client 256.

The file storage module 246 stores the entire file, which includes not only the file contents, but also the file name and file meta-data. The file meta-data includes, but is not limited to, a user-defined file name, the unique file identifier (whether a unique hash of the contents or another unique identifier), a file storage path identifying the storage location in the cloud file structure 212 (and/or cloud file structure 220), and a file contents version identifier. Other meta-data that can also be included the file storage location in the client file structure 260 (as described below) at the computing device 248, or other meta-data.

The computing device 248 includes, for example, a browser 250 and a first user client 264. The first user client 264 further includes a client file structure 260, a sync engine 264, and an indexer 268.

The computing device 248 includes any generic computing device as described in connection with FIG. 1, such as a mobile computing device (e.g., a tablet, a laptop, a mobile phone), a desktop computer, or other similar device.

The browser 250 includes any software for displaying Web-based content at the first computing device 248. Examples of the browser 250 include, but are not limited to, GOOGLE CHROME, INTERNET EXPLORER, and MOZILLA FIREFOX.

The first user client 256 is configured to edit, find, and locally store files on the computing device 248 as well as communicate with the cloud storage system 204 via the server 228 to further facilitate convenient searching, editing, sharing, and synchronizing of files and objects. The first user client 256 stores files locally (i.e., at the device 248) in a client file structure 260 that, as mentioned above, is defined by the user of the computing device 248 and, unlike conventional cloud synchronization systems, is not defined by the cloud storage system 204.

In the client file structure 260, the user of the first computing device 248 can open, name, edit, and organize the file in the client file structure 260 independent from a cloud file structure (e.g., cloud file structure A 212 or cloud file structure B 220). In one embodiment, the client file structure 260 is created with reduced user input by referring to user preferences and by characterizing each file according to various organization criteria identified by the user. These criteria can include, for example, a project name or identifier, a project type, a project phase, a client name or identifier, file organization folder and sub-folder names, a design file type and/or sub-type, file subject matter type and sub-type, and combinations thereof. These criteria that are used to characterize a file in combination with the organizational user preferences stored by the user can then be used to automatically create a client file structure 260 in which a newly downloaded or synchronized file is stored.

For example, consider “FirstFloor.dwg” which is in project “657 Broadway” and is of type “drawings” with category “floor plans.” On three different user machines, the “FirstFloor.dwg” may be stored as:
Machine 1: C:\construcs\657 Broadway\drawings\FirstFloor.dwg
Machine 2: C:\construcs\657 Broadway\drawings\floor plans\FirstFloor.dwg
Machine 3: C:\construcs\657 Broadway\FirstFloor.dwg

Indeed the organization of the local files can vary adaptively If there were only a few files in 657 Broadway (because it was a small project), a user client could simplify the path to just the project name. As the number of files grows past a threshold, the user client could add the file type folder, and later the file category folder.

The sync engine 264 is used to synchronize a file between a version stored locally at the first user client 256 and a version stored at the cloud storage system 204. In one example, the sync engine 264 identifies changes made to locally stored file contents and transmits the file contents and meta-data used to uniquely identify the file and its storage location (as explained above) to the file coordinator 236. The file coordinator then locates the corresponding file contents stored at the cloud storage system 204 and updates them.

In another example, the sync engine 264 is used to determine differences between file contents of a file stored at the file storage module 246 of the server 228 and file contents of the file stored locally at the first user client 256, and determine the source of the differences. These differences can arise from the function of the system 200, which permits multiple users to find, receive, rename, edit, reorganize, and store contents of the same file. For example, the first computing device 248 and the second computing device 252 can both download the same file contents from the file storage module 246 of the sever 228. And both the first computing device 248 and the second computing device 252 can independently store, edit, and save the file in client file structures 260 and 280 respectively. The conflict arises when the file contents from both the first computing device 248 and the second computing device 252 are then synchronized with the file storage module 246, leading to differences in the file locally and at the server 228.

To resolve these differences, the sync engine 264 locally stores the file contents, file meta-data (including file contents hashes and the file path of the client file structure 260) and a reference copy of the file contents as either received from or uploaded (whichever is most recent) to the server 228. This local copy of the file contents in the file storage module 246 is uniquely named with a hash of the file contents. By storing the reference copy locally, the presence and source of differences between versions can be identified. Furthermore, this can be done very efficiently by comparing file hashes. That is, the sync engine 264 can unambiguously determine whether a change occurred in the file contents at the cloud storage system 204 or at the computing device 248.

One benefit of the system 200 is that file contents of file can be synchronized by the sync engine 264 on all instantiations of the file stored at multiple locations. That is, because a file is uniquely identified regardless of the location at which it is stored (e.g., multiple storage locations on the computing device 248, at the file storage module 246, at the cloud storage system 204) and the storage locations are identified in meta-data at the file mapper 244, a change to one instantiation of a file causes synchronization across all instantiations of the file regardless of storage location by reference to the file mapper 244. In this example, all instantiations of a file are synchronized with a single, cloud stored instantiation of the file. This benefit reduces the risk of out of date versions being improperly used and improves user convenience by reducing the amount of manual, user-directed synchronization.

A variation of system 200 allows a user client (“FSUC”) to run on a file server inside an organization's firewall. When the first user client 256 is inside the organization's firewall (i.e., inside a LAN), the sync engine 264 contacts the FSUC to source files before downloading from the server 228. In this way, the FSUC at the LAN communicates with the first and second user clients, and with the server.

The local client uses its IP address and gateway address as a heuristic to determine if it is within the organization's LAN. If these match, the local client attempts to connect to FSUC. The first user local client 256 obtains the FSUC IP address, gateway IP address, and LAN subnet mask from the server 228, these having been uploaded to the server when the FSUC is first setup. If connection is accepted by the FSUC, the first user client 256 downloads and uploads files to the FSUC. The FSUC itself synchronizes with the server 228, acting as a normal user client as far as the server is concerned. There are at least three benefits to having an FSUC.
1. In many cases this avoids having to download files from the cloud, because instead they are transmitted over the organization's LAN. This is faster for the user because it omits transmission of the file through the Internet.
2. It avoids repeated transmission of the same file that might clog up the organization's

Internet connection.
3. By reducing the download delay, it helps prevent conflicts between different edits of the same file in the event that several people are concurrently changing the same file.

Upon downloading a file from the server 228 file storage module 246 to the first user client 256, conflicts between file contents can be resolved by, for example, the sync engine 264 confirming that the appropriate destination folder for the file exists in the client file structure 260. The sync engine 264 confirms also that the reference file is either stored locally or is downloaded from the file storage module 246 and then stored locally as described above. The locally stored file contents and the reference file contents are compared, which can be done very efficiently by comparing file hashes, to determine if any inconsistencies exist and whether the inconsistencies were caused by a recently edited local version or a version recently uploaded to the file storage module 246 by another computing device.

Updates to files can be made by transmitting only the differences between the various versions of the file, thereby reducing the bandwidth usage, and transmission time compared to uploading or downloading the entire file. This is possible because of the reference copy of the file contents as either received from or uploaded (whichever is most recent) to the server 228. The reference copy can be compared with the altered local copy to identify the changes. Furthermore, if the inconsistency identified includes an out of date version stored in the client file structure 260 but a current reference file stored locally, the reference file can be copied and saved in the client file structure 260 without resorting to downloading the current version from the file storage module 246 of the server 228 or the cloud storage system 204. By copying the locally stored reference copy, the response time of the synchronization is improved, bandwidth consumption is reduced, and needless use of computing resources of the system 200 is avoided.

In another embodiment, the first user client 256 creates the first user client file structure and displays file placeholders for the files available to a user without first downloading the file contents. The file placeholders appear as normal file icons but do not actually include file contents. Instead, the file contents associated with a file placeholder are downloaded by the first user client 256 when a user selects the file placeholder. The file placeholders created in a file structure may correspond to all the files a user has access to or just those from specific projects. The benefit of this approach is that the user can see all his files without consuming network bandwidth and computational resources needed to download the files contents of all the files.

The placeholders are files of a special type (for example, identified by a special file extension, such as “.con”) . When the first user client 256 is installed on the first user computing device 250, it registers itself as the program to be used to open files of the special type. The placeholder, which contains file metadata corresponding to the file contents, communicates with the first user client 256 when opened by the user. The first user client 256 reads the metadata from the placeholder, uses the metadata to find and download the real file, opens the file contents, and deletes the placeholder. To save storage space on the first user computing device 250, the process may be reversed so that large files are replaced by placeholders.

In another embodiment, the first user client 256 includes an indexer 268 that creates and synchronizes an index of the files stored on computing device 248. For example, each computing device 248 and 252 includes its own indexer associated with the user client on the computing device, in this case, indexers 268 and 288.

In one example, the indexer 268 creates the index by identifying keywords from the locally stored files and storing the keywords in a text indexing system such as Lucene/SOLR or, on the server, Elasticache. The indexes can be searched using an API provided by the text indexing system. The indexes are uploaded to the file coordinator 236 of the server 228 and can be synchronized as described below.

A second computing device 252 that includes a second user client 276 is shown to illustrate that embodiments of the present disclosure are not limited merely to one user client, but multiple (one or more) user clients each with a different file structure.

### Browser-Based File Management

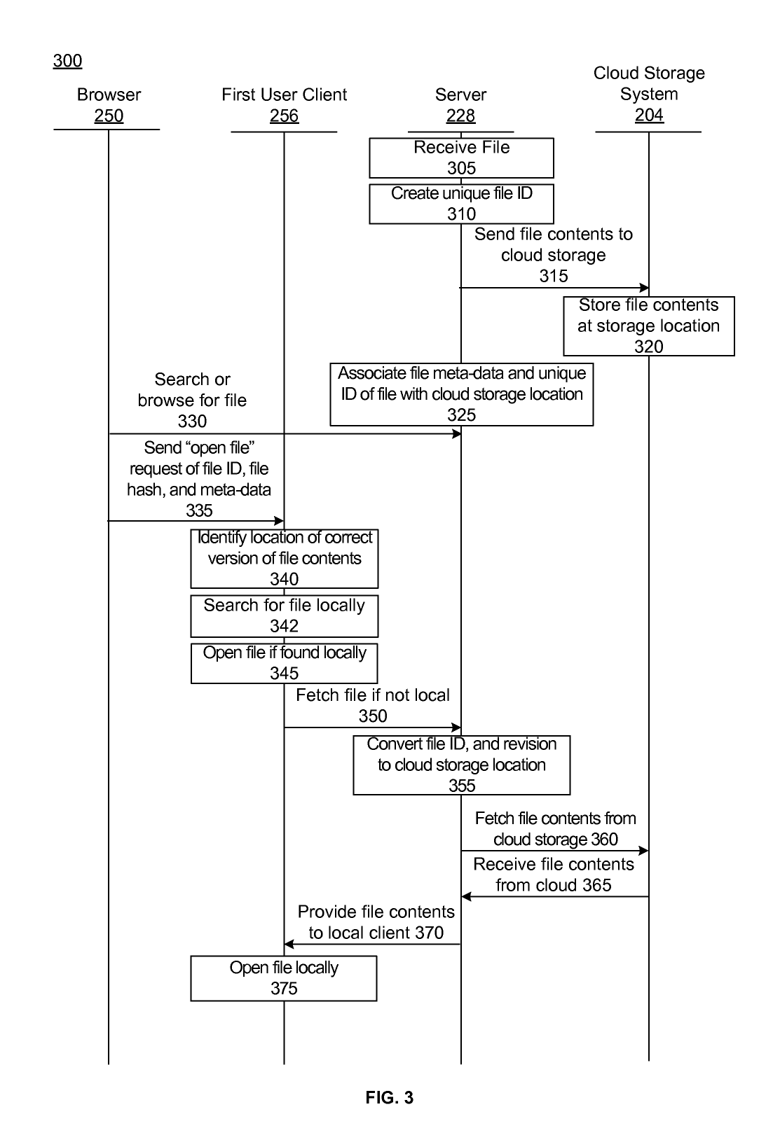

Referring now to FIG. 3, it illustrates one example method of using the browser 250 (or alternatively browser 272) to locate a file for viewing and/or editing and opening the file directly using the browser. This is different from conventional systems in which the identified file must first be downloaded to a computing device, the file path individually customized by the user, and the file opened by the user after downloading. By contrast, the method of FIG. 3 provides an added degree of convenience for the user by, in connection with the system 200, permitting users to locate and edit file contents without multiple steps using multiple computer applications to merely open and save the file in a file structure 260.

The method 300 begins by receiving 305 a file at the server 228. As described above, the received file includes file contents and meta-data that are stored in the file storage module 246. Upon receipt, a unique file ID is created 310 and the file contents are sent 315 to the cloud storage system 204. The cloud storage system stores 320 the file contents at a cloud storage location. In one example, the cloud storage location is determined and recorded by the storage adapter 232 of the server 228. In another example, the cloud storage location is determined by the cloud storage system 204 which then communicates the storage location to the server 228. Regardless of how the cloud storage location is determined, the server associates 325 the file meta-data, which includes the cloud storage location of the file and the unique file ID, with the file contents. In some example, the system 200 operates as described above to download and/or synchronize files with a user client.

Having performed the above, a browser 250 at a first user client 256 can search or browse 330 for the file. Upon finding the file, the browser sends 335 a request to open the file. This request includes sending 335 the unique file ID, a hash of the file contents, and other meta-data to the first user client 256.

The first user client 256 identifies 340 the location of either the requested version (whether the most current version or not) of the file contents as described in the context of FIG. 2 Optionally, the first user client 256 can search for the requested version of the file contents locally 342 before searching at the server 228 or the cloud storage system 204. If found locally, the file is opened locally 345, thereby conserving bandwidth and computing resources, and avoiding downloading redundant versions of the file that can cause confusion.

If the file is not found locally, the first user client 256 sends a fetch request 350 to the server 228 using the file meta-data. The server 228 uses the received meta-data to identify 355 the cloud storage location and requested version and then fetches 360 the file contents from the cloud storage location. The server 228 receives 365 the file contents and provides 370 the file contents to the first user client 256. The first user client 256 then opens 375 the file contents locally.

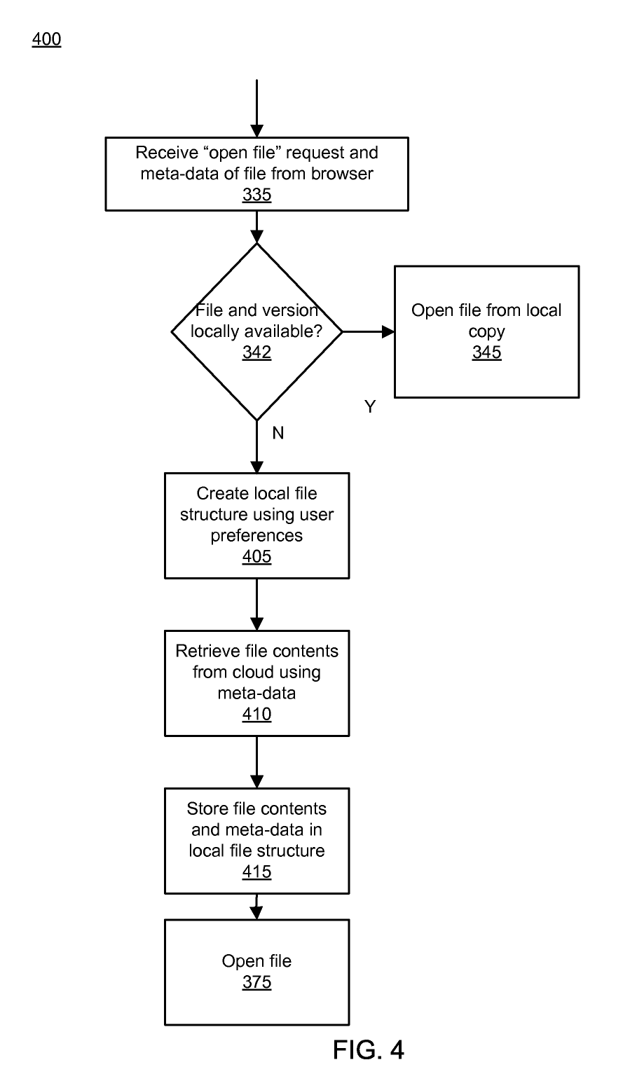

FIG. 4 illustrates an example sub-method 400 of method 300 further detailing a process for fetching 350 file contents from the server 228 if the file contents are not found locally. If the file contents of the requested version are not found locally 342, the first user client 256 creates 405 a local file structure using user defined preferences and the meta-data of the file, as described above. Once the file structure has been created locally, the first user client 256 retrieves 410 the file contents from the cloud storage system 204 using the meta-data provided by the request for the file. Once retrieved, the first user client 256 stores 415 the file contents and meta-data at the appropriate local storage location in the created file structure. Then, as described in the context of FIG. 3, the file is opened 375.

### Other Applications

The disclosed embodiments beneficially allow for the sharing of files and projects between users, organizations, projects, and storage platforms. In some examples, sharing files using the methods and systems described herein is particularly useful in the architectural, structural engineering, and design (whether industrial design, product design, interior design, etc.) contexts. These design files, drawings, and other project related content can be re-used between projects despite difference between projects. In some examples, because of the versatility of particular files, some files may be used in even very different projects. For example, a design file for a spiral staircase can be re-used in an architectural design for accessing a pedestrian overpass of a highway, or for a stairwell in an opera house. Other types of files having a similar re-usability can also include, but are not limited to, specifications, codes, products, spreadsheets, html pages, web links, images, project schedules, background information, maps, audio or video stream, data library, application, or other collection of data.

Another benefit of the disclosed embodiment is that they enable users to access and edit file contents even when unconnected to the network 224. Users may also save new files into the client file structure 260 when unconnected to the network 224. Upon reconnection, the sync engine 264 will synchronize any updated files in background as soon as connection to the network 224 is restored.

In yet another embodiment demonstrated in FIG. 5, the thin client is synchronizing both the original file and a graphical representation of the asset (i.e. the preview file) between the local file system and the cloud storage system. Synchronizing of preview files uses the same underlying file synchronization mechanism as other files. The Preview file is used and displayed within the disclosed system when search results are rendered. Preview generation occurs regardless of whether the user has the required software installed on their local system. If a preview file cannot be generated locally the thin client submits the local file to the preview generation server. In response it receives the graphical representation that is stored locally and in CONSTRUCS database. Local previews are utilized to improve performance by reducing number of web-requests and network transportation overhead. If for whatever reason local preview file is unavailable system will attempt to load it from CONSTRUCS server.

Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for enabling files and/or objects to be transmitted from a cloud-based storage system to at least one user client and stored in at least one user-defined file structure that is different from the file structure of the cloud system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving a file comprising file contents, a file name, and meta-data;
storing the file contents at a first cloud storage location the first cloud storage location added to the meta-data; and
providing the file comprising the file contents, the file name, and the meta-data to a first user client, the provided file stored at the first user client at a first user client storage location in a first user client file structure, the first user client file structure different from the cloud storage file structure, the first user client file structure created using the first user client storage and first user client preferences.

2. The method of claim 1, further comprising:
receiving a request from a browser of the first user device to access the file contents transmitting a request to the user client to initiate downloading the file contents, the
transmitted request comprising:
instructing first user client to download the file contents stored at the cloud storage location;
using the meta-data of the file to identify the cloud storage location;
instructing the first user client to store the file contents at the first user client storage location; and instructing the first user client to open the file contents.

3. The method of claim 1, wherein providing the file further comprises:
providing a file placeholder to the first user client, the file placeholder comprising file meta-data used for locating the file contents;
receiving a user selection of the file placeholder, the user selection transmitting the meta-data associated with the file placeholder; and
responsive to receiving the user selection of the file placeholder and the meta-data, providing the file to the first user client.

4. The method of claim 1, further comprising:
receiving a request to access the file contents from a second user client, the request identifying the file contents using the file meta-data;
determining whether the second user client includes a second user file structure for storing the file contents;
responsive to determining the second user file structure is absent, creating the second user file structure using stored second user preferences; and
storing the file contents from the first cloud storage location at the second user client file structure different from the first user client file structure and different from the first cloud storage file structure.

5. The method of claim 1, further comprising:
providing a second copy of the file to the first user client and storing the second copy at a second user client storage location different from the first user client storage location; receiving a change to the second copy of the file; and
changing the file stored at the first user client storage location according to the change received from the second copy of the file.

6. The method of claim 1, further comprising:
providing a second copy of the file to a second user client;
receiving a change to the second copy of the file; and
changing the file stored at the first user client according to the change received from the second copy of the file.

7. The method of claim 1, further comprising:
receiving a change to the file; and
changing the file stored at the first cloud storage location according to the change received from the file.

8. The method of claim 1, further comprising:
receiving an instruction to move the file from the first cloud storage location at a first cloud-based storage system to a second cloud storage location at a second cloud-based storage system;
storing the file contents at the second cloud storage location at the second cloud-based storage system; and
updating the meta-data to identify the storage location of the file contents as the second cloud storage location.

9. The method of claim 1, further comprising:
receiving a changed hash of the file contents, the file contents changed by the user; identifying the changes in the file contents by comparing the changed file contents to a reference copy of the file contents; and
changing the file contents at the cloud storage location to include the identified changes by transmitting only the changes in the file contents.

10. The method of claim 1, wherein the first user client is on the first user computing device in the same local area network in communication as a second user client is on a second user computing device;
the second user client obtains the file contents by requesting it from the first user client.

11. A system comprising:
a file storage module for receiving and storing file contents, a file name, and meta-data;
a file mapping module for identifying the file name with the file contents;
a storage adapter for storing the file contents at a first cloud storage location , the first cloud storage location added to the meta-data; and
a server for providing the file comprising the file contents, the file name, and the meta-data to a first user client, the provided file stored at the first user client at a first user client storage location in a first user client file structure, the first user client file structure different from the cloud storage file structure, the first user client file structure created using the first user client storage and first user client preferences.

12. The system of claim 11, further comprising:
a web browser for finding and opening the latest version of the file contents;
a user client for receiving a request from the web browser to access the latest version of the file contents; and
a sync engine for searching for a storage location of the latest version of the file contents by searching a computing device responsive to the request by the user client.

13. The system of claim 11, wherein the first user client is on the first user computing device in the same local area network in communication as a second user client is on a second user computing device;
the second user client obtains the file contents by requesting it from the first user client.

14. The system of claim 11, wherein the server is further configured for transmitting a request to the user client to initiate downloading the file contents, the transmitted request comprising:
using the meta-data of the file to identify the first cloud storage location of the file contents;
instructing first user client to download the file contents stored at the cloud storage location;
instructing the first user client to store the file contents at the first user client storage location; and
instructing the first user client to open the file contents.

15. The system of claim 11, wherein the server is further configured for providing the file, the providing further comprising:
providing a file placeholder to the first user client, the file placeholder comprising file meta-data used for locating the file contents;
receiving a user selection of the file placeholder, the user selection transmitting the meta-data associated with the file placeholder; and
responsive to receiving the user selection of the file placeholder and the meta-data, providing the file to the first user client.

16. The system of claim 11, wherein the server is further configured for:
providing a second copy of the file to the first user client and storing the second copy at a second user client storage location different from the first user client storage location;
receiving a change to the second copy of the file; and
changing the file stored at the first user client storage location according to the change made to the second copy of the file.

17. The system of claim 11, wherein the server is further configured for::
providing a second copy of the file to a second user client;
receiving a change to the second copy of the file; and
changing the file stored at the first user client according to the change received from the second copy of the file.

18. The system of claim 11, wherein the server is further configured for::
receiving a change to the file; and
changing the file stored at the first cloud storage location according to the change received from the file.

19. The system of claim 11, the server further configured for:
receiving a request to access the file content from a second user client, the request identifying the file contents using the file meta-data;
determining whether the second user client includes a second user file structure for storing the file contents;
responsive to determining the second user file structure is absent, creating the second user file structure using stored second user preferences; and
storing the file contents from the first cloud storage location at the second user client file structure different from the first user client file structure and different from the cloud storage file structure.

20. A non-transitory computer readable medium configured to store instructions, the instructions when executed by a processor causing the processor to:
receive a file comprising file contents, a file name, and meta-data;
store the file contents at a first cloud storage location, the first cloud storage location added to the meta-data; and
provide the file comprising the file contents, the file name, and the meta-data to a first user client, the provided file stored at the first user client at a first user client storage location in a first user client file structure, the first user client file structure different from the cloud storage file structure, the first user client file structure created using the first user client storage and first user client preferences.

21. The non-transitory computer readable medium of claim 20, further comprising instructions causing the processor to: receive a request from a browser of the first user device to access the file contents;
transmit a request to the user client to initiate downloading the file contents, the transmitted request comprising instructions causing the processor to:
use the meta-data of the file to identify the cloud storage location;
instruct first user client to download the file contents stored at the cloud storage location;
instruct the first user client to store the file contents at the first user client storage location; and
instruct the first user client to open the file contents

22. The non-transitory computer readable medium of claim 20, further comprising instructions causing the processor to:
receive a request to access the file content from a second user client, the request identifying the file contents using the file meta-data;
determine whether the second user client includes a second user file structure for storing the file contents;
responsive to determining the second user file structure is absent, create the second user file structure using stored user preferences; and
store the file contents from the first cloud storage location at the second user client file structure different from the first user client file structure and different from the cloud storage file structure.

23. The non-transitory computer readable medium of claim 20, further comprising instructions causing the processor to:
provide a file placeholder to the first user client, the file placeholder comprising file meta-data used for locating the file contents;
receive a user selection of the file placeholder, the user selection transmitting the meta-data associated with the file placeholder; and
responsive to receiving the user selection of the file placeholder and the meta-data, provide the file to the first user client.

24. The non-transitory computer readable medium of claim 20, further comprising instructions causing the processor to:
provide a second copy of the file to the first user client and storing the second copy at a second user client storage location different from the user client storage location;
receive a change to the second copy of the file; and
change the file stored at the first user client storage location according to the change received from the second copy of the file.

25. The non-transitory computer readable medium of claim 20, further comprising instructions causing the processor to:
provide a second copy of the file to a second user client;
receive a change to the second copy of the file; and
change the file stored at the first user client according to the change received from the second copy of the file.

26. The non-transitory computer readable medium of claim 20, further comprising instructions causing the processor to:
receive a change to the file; and
change the file stored at the first cloud storage location according to the change received from the file.
